(19) United States
(12) Patent Application Publication
(10) Pub. No.: US 2002/0193032 A1
(43) Pub. Date: Dec. 19, 2002

(54) Nonwoven fabric with areas of differing basis weight

(75) Inventors: David D. Newkirk, Greer, SC (US); Michael M. Thomason, Simpsonville, SC (US); Jay D. Gillespie, Simpsonville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BBA Nonwovens Simpsonville, Inc.

(21) Appl. No.: 10/141,041

(22) Filed: May 8, 2002

Related U.S. Application Data
(60) Provisional application No. 60/295,329, filed on Jun. 1, 2001.

(51) Int. Cl. B32B 5/26; B32B 27/12; D04H 1/56

(52) U.S. Cl. 442/401; 442/382; 442/394; 442/400

(57) ABSTRACT

A spunbond nonwoven fabric is provided from a multiplicity of substantially continuous filaments which form a web having a length dimension and a width dimension. The filaments are arranged to define a substantially uniform web basis weight along one of dimension of the fabric, while in the other dimension, the filaments are arranged to define adjacent zones of a relatively lower web basis weight and a relatively higher web basis weight which is at least 25 weight percent greater than the basis weight of the lower basis weight zone. The spunbond nonwoven fabric can be combined with one or more additional layer to form a composite nonwoven fabric. The fabric is useful in various articles that utilize nonwovens, such as diapers, protective clothing, and hygiene articles.

### CROSS REFERENCE TO RELATED APPLICATIONS

This application is related to and claims priority from U.S. Provisional Application No. 60/295,329, filed Jun. 1, 2001.

### FIELD OF THE INVENTION

This invention relates to nonwoven fabrics, and more particularly to nonwoven fabrics that are constructed so as to have differing physical properties in different areas or zones of the fabric.

### BACKGROUND OF THE INVENTION

Nonwoven fabrics are used in a variety of disposable products in various applications including medical products, protective garments, and absorbent hygiene articles such as diapers, adult incontinence products and feminine hygiene articles. Many of these products use nonwovens in the form of composites of a nonwoven layer with one or more additional nonwoven or film layers. One class of such nonwoven composite is commonly referred to as a spunbond/meltblown/spunbond (or SMS) laminate. This laminate generally consists of nonwoven outer layers of spunbond polyolefin filaments and an inner layer of polyolefin meltblown fibers.

In one well-known spunbond manufacturing process, commonly referred to as the “Lurgi” process, the freshly extruded filaments are attenuated and drawn by a series of tubular pneumatic jets, often referred to as Lurgi tubes, as disclosed in Dorschner et al. U.S. Pat. No. 3,692,618. Another known spunbond process, often referred to as a “slot-draw” process, uses a pneumatic attenuator device in the form of an elongate slot extending widthwise across the collection belt. An example of a slot-draw spunbond process and apparatus is described in U.S. Pat. No. 5,397,413.

In the manufacture of spunbond nonwoven fabrics, the presence of irregularities or thin spots in the fabric is considered a serious quality issue. Considerable effort is made to assure that the filaments are distributed uniformly throughout the fabric. In some instances, undesirable regions of high basis weight and low basis weight can occur across the cross-machine (CD) direction and extending in the machine direction (MD). This kind of irregularity in the web basis weight is commonly referred to as gauge bands. Users of nonwoven fabric express grave concern to the nonwoven manufacturer when they detect gauge bands in the nonwoven fabrics. Gauge bands cause slitting issues, web control issues and interfere with lamination of the nonwoven fabric with other materials. Consequently, careful attention is given to equipment design and to standard operating procedure developments to minimize the creation of MD and CD variations in the basis weight of the fabric. For example, devices such as those shown in U.S. Pat. Nos. 5,225,018 and 5,397,413 provide an electrostatic charge on the filaments to assure more uniform distribution of the filaments.

While variability in the basis weight of nonwoven fabrics has heretofore always been considered to be undesirable, the present invention is based upon the recognition that for certain specific end-use applications a nonwoven fabric having areas engineered to have differing physical properties can provide unique solutions for the design of components employing the nonwoven fabrics. It is unexpected and contrary to the usual practice of those skilled in the art that nonwoven fabrics with purposefully engineered regions of differing physical properties would yield a product with enhanced nonwoven properties such as strength, barrier, opacity, or aesthetic effect.

### SUMMARY OF THE INVENTION

Accordingly, the present invention provides a spunbond nonwoven fabric having zones of differing basis weight engineered into the fabric. More specifically, the present invention provides a spunbond nonwoven fabric comprising a multiplicity of substantially continuous filaments which form a web having a length dimension and a width dimension. The filaments are arranged to define a substantially uniform basis weight along one dimension of the fabric. Along the other dimension, the filaments are so arranged to define adjacent zones of a relatively lower basis weight and a relatively higher web basis weight. These areas of differing basis weight are purposefully engineered into the fabric in selected and predictable regions so that the areas of higher and lower basis weight can be advantageously incorporated into specific portions of an article using this nonwoven fabric as a component. Furthermore, the differences in basis weight are statistically significant and well outside of the random and non-reproducible variations that have heretofore been regarded as defects, such as undesirable gauge bands. In one specific embodiment, the zones of relatively higher web basis weight are at least 25 weight percent greater than the lower basis weight zone. In a further embodiment, the basis weight of the higher basis weight zone is at least 40 weight percent greater than the basis weight of the lower basis weight zone. In still another specific embodiment, the basis weight in the higher basis weight zone is about twice that in the lower basis weigh zone.

The nonwoven fabric of the invention is suitably provided in the form of roll goods of a predetermined substantially uniform width and of indeterminate length. The zones of relatively lower and higher basis weight are located across the width or cross-machine direction and extend continuously in the length or machine direction.

### BRIEF DESCRIPTION OF THE DRAWINGS

Having thus described the invention in general terms, reference will now be made to the accompanying drawings, which are not necessarily drawn to scale, and wherein:

FIG. 1 is a top plan view showing a nonwoven fabric in accordance with the invention;

FIG. 2 is an exaggerated cross-sectional view of a portion of the nonwoven fabric of FIG. 1;

FIG. 3 is a cross-sectional view of a composite nonwoven fabric in accordance with one embodiment of the invention;

FIG. 4 is a cross-sectional view of a composite nonwoven fabric in accordance with another embodiment of the invention;

FIG. 5 is a cross-sectional view showing a portion of a diaper including the nonwoven fabric of the present invention; and

FIG. 6 is a schematic plan view showing how a Lurgi spunbond apparatus may be configured for producing nonwoven fabrics in accordance with the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As used herein, the term “nonwoven fabric” or “nonwoven web” refers to a web formed of individual fibers or filaments which are interlaid, but not in an identifiable repeating pattern.

As used herein, the term “spunbond” fabric or web refers to a web formed by extruding molten thermoplastic polymer material in the form of substantially continuous filaments from a plurality of fine, usually circular, capillaries of a spinnerette. The molten filaments are quenched by contact with cooling air and are then attenuated either mechanically or pneumatically, which draws the filaments to a smaller diameter. The drawn filaments are then deposited on a collection surface, such as a conveyor belt, to form a nonwoven web. The web may be subsequently bonded to form a unitary and coherent fabric. The filaments of a spunbond fabric typically have a denier of from about 1-10 denier per filament (DPF). The thermoplastic polymer material used to make the filaments of a spunbond fabric can be any of various fiber forming polymers including polyolefins such as polypropylene and polyethylene, polyesters such as poly(ethylene terephthalate), polyamides such as poly(hexamethylene adipamide) and poly(caproamide), and blends and copolymers of these and other known fiber forming thermoplastic materials. The spunbond filaments may also be multicomponent or multiconstituent filaments containing two or more different polymer compositions.

As used herein, the term “meltblown fibers” refers to fibers which are formed by extruding molten thermoplastic material as threads or filaments through a plurality of fine, usually circular capillaries of a die. A high-velocity, usually heated gas (e.g., air) stream attenuates the extruded thermoplastic material to form fine diameter meltbown fibers. Thereafter the meltblown fibers are carried by the high-velocity heated gas stream and are deposited on a collecting surface to form a web of randomly dispersed meltblown fibers. Meltblown fibers differ from the filaments of a spunbonded web in that the extruded polymer strands typically have a much finer diameter. These fine diameter fibers are easily dispersed by the forced hot air stream before being deposited on the collecting surface. In addition, the meltblown fibers are substantially cooled by the air so that they do not significantly bond together.

As used herein “basis weight” refers to the weight of a fabric or web per unit area, usually expressed in grams per square meter (GSM). Basis weight is measured using ASTM D3776-96.

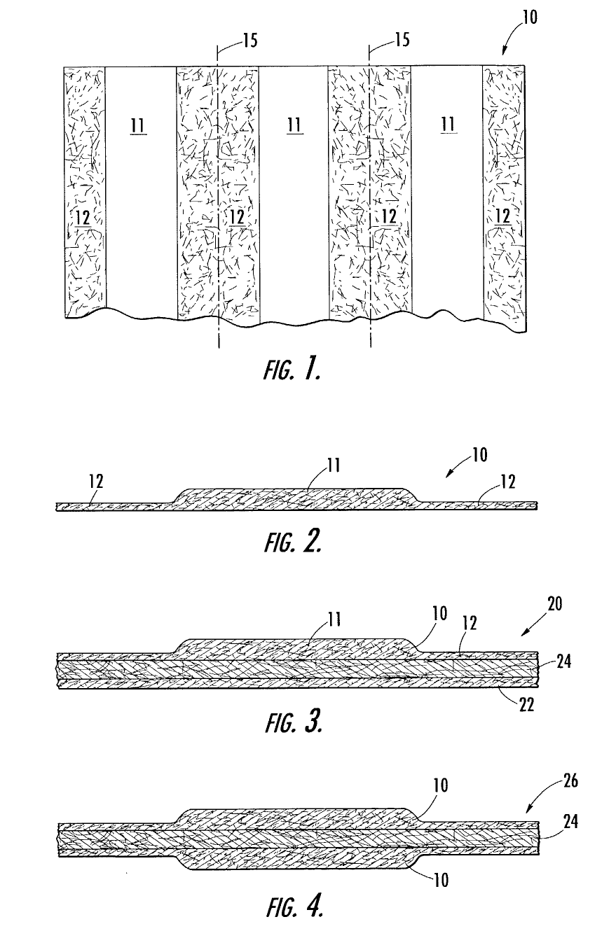

A spunbond nonwoven fabric in accordance with the present invention is indicated by the reference number 10 in FIG. 1. As manufactured, the nonwoven fabric has a substantially uniform width, measured along the dimension conventionally referred to as the cross direction or cross-machine direction (CD) and it has an indeterminate length along the machine direction (MD). As shown, the fabric has zones 11 of a relatively high basis weight and zones 12 of a relatively lower basis weight extending longitudinally in the machine direction of the fabric. More specifically, the higher basis weight zones 11 define bands separated in the cross-machine direction by adjacent contiguous bands of lower basis weight. Within each zone or band, the fabric basis weight is substantially uniform. At the juncture between the higher basis weight zone 11 and the lower basis weight zone 12 there is a gradual transition in basis weight. The number, width and spacing of the zones or bands across the CD of the nonwoven fabric can be varied as needed, depending upon end-use requirements. After manufacturing, the fabric 10 may be longitudinally slit to form an intermediate product in roll form for use in end-product manufacture, with the higher and lower basis weight zones being located in specific areas as required by the end product. For example, for one kind of intermediate product useful for diaper manufacture, the fabric may be silt along slit lines indicated at 15 to form fabric strips having a central zone of relatively heavy basis weight, with marginal side edge zones of lower basis weight.

As shown in FIG. 2, the central, relatively heavy basis weight zone is of greater thickness than the marginal side edge zones of lower basis weight. Preferably, the zones 11 have a basis weight at least 25 percent greater than the basis weight of the zones 12, and most desirably, the basis weight of the higher basis weight zones 11 is at least 40 percent greater than that of the lower basis weight zones 12. For certain specific applications, it is preferred that the basis weight of the heavier zone 11 be twice the basis weight of the lighter zone 12, or even 125% of the basis weight of the lighter zone. The difference in basis weight is purposeful and is well outside of the normal variations in basis weight encountered in conventional manufacturing processes. The filaments of the spunbond web are bonded together by discrete thermal point bonds.

FIG. 3 illustrates a composite nonwoven fabric 20 in accordance with one embodiment of the present invention. As one of its outermost layers, the composite fabric 20 includes a spunbond nonwoven fabric 10 manufactured with adjacent high basis weight zones 11 and lower basis weight zones 12. The opposite outermost surface of the composite nonwoven fabric 20 is defined by a nonwoven layer 22 of a conventional spunbond nonwoven fabric of uniform basis weight throughout. Between the two outermost spunbond layers 10, 22 is a layer 24 of meltblown fibers. The respective layers are joined together to form a unitary composite nonwoven fabric by discrete spaced apart fusion bond zones. Preferably, the bond zones comprise thermal point bonds produced from a heated calender nip defined by a smooth calender roll and a cooperating patterned or embossed calender roll having raised bonding bosses which cover approximately 10 to 30 percent of the area of the roll.

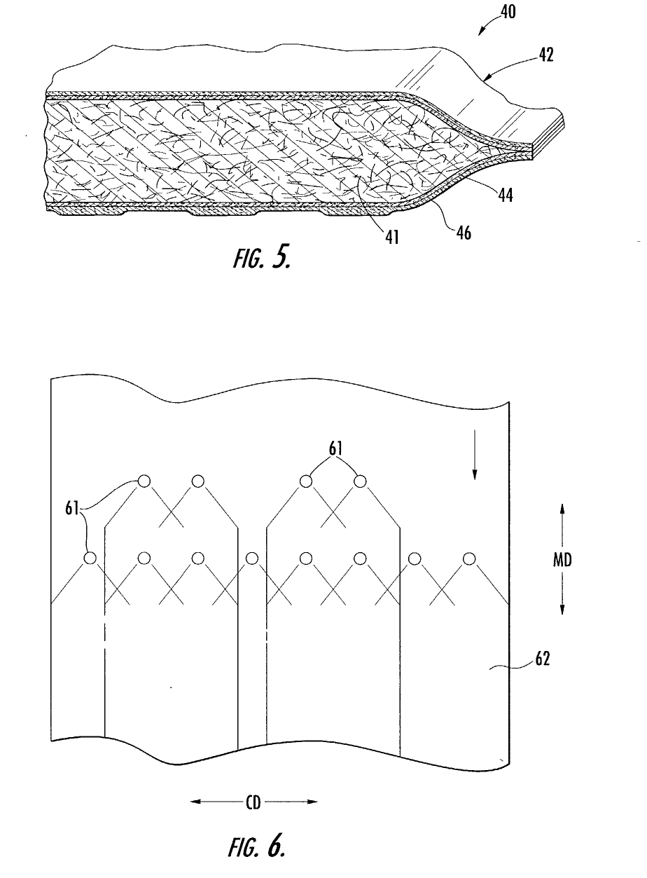

FIG. 4 illustrates a composite nonwoven fabric 26 in accordance with a further embodiment of the present invention. In this embodiment, both of the outermost layers comprise a spunbond nonwoven fabric 10 having zones of higher and lower basis weight. As illustrated, the higher basis weight zones 11 of the respective layers are located opposite one another, in registration, and the lower basis weight zones 12 are likewise in registration with one another. A layer 24 of meltblown fibers is located between the outermost layers 10. The respective layers are bonded together to form a unitary composite nonwoven fabric by discrete thermal point bonds. If desired, one of the zones, e.g. the lower basis weight zone, may be treated with a surfactant. For other applications, a composite film/fabric laminate can be produced using a nonwoven fabric such as that shown in FIG. 1. The spunbond nonwoven fabric may be laminated to a preformed film, which may be an impermeable film or a breathable film, or the nonwoven fabric may be extrusion coated with a film-forming polymer composition.

FIG. 5 is a cross-sectional view showing a portion of a diaper 40 including the nonwoven fabric of the present invention. The diaper includes an absorbent core 41 formed of fluff pulp, or a blend of fluff pulp and a superabsorbent polymer, and a nonwoven outer layer 42 on one surface of the core serving as the topsheet of the diaper. On the opposite side of the diaper, a film backsheet layer 44 overlies the absorbent core. A nonwoven fabric 46 overlies the film backsheet 44 to form an aesthetically pleasing outer surface for the diaper. The nonwoven backsheet layer 46 may be provided with zones of higher and lower basis weight in accordance with the present invention. The heavier basis weight areas serve as reinforcement so that a lighter and more breathable film layer can be used. Also, depending upon the spacing and arrangement of the zones, the fabric 46 can give the outer surface of the diaper an aesthetically pleasing tactile effect and also form a visually pleasing pattern of stripes or bands.

FIG. 6 schematically illustrates how the attenuator tubes of a Lurgi type spunbond apparatus may be configured for producing nonwoven fabrics in accordance with the present invention. In a conventional setup, the Lurgi tubes are uniformly distributed along the cross machine direction (CD) so that a uniform concentration of filaments is deposited onto the forming wire across the CD direction. However, as shown in FIG. 6, the attenuator tubes 61 are arranged in two rows. A first row of uniformly spaced apart tubes deposits a uniform concentration of filaments across the entire width of the forming belt 62. A second row of tubes 61 can be located a short distance upstream or downstream from the first row for producing an additional deposit of filaments in selected areas across the CD direction. These areas will correspond to the heavy basis weight zones in the resulting nonwoven fabric.

The resulting unbonded nonwoven web, containing alternating zones of higher basis weight and lower basis weight, can be directed through a calender and bonded to form a unitary coherent spunbonded nonwoven fabric. In a subsequent step, this spunbonded fabric can be combined with one or more additional layers to produce a composite nonwoven fabric. For example, the spunbonded nonwoven fabric can be unrolled and directed beneath a meltblowing die and a layer of meltblown fibers can be deposited directly onto the spunbond fabric. Then, an additional spunbond layer can be applied to form a spunbond/meltblown/spunbond composite laminate. Alternatively, the composite nonwoven fabric can be formed in-line by directing the unbonded spunbond web past a meltblowing beam and past a subsequent spunbond beam, with the composite thereafter being bonded such as by calendering.

A spunbond nonwoven fabric in accordance with the present invention could also be produced using a modified slot draw spunbond apparatus. The gap in selected regions of the slot may be opened so that an extra flow of high pressure air is directed through the selected region or regions, such that extra filaments are directed through such regions. Alternatively, deflectors may be positioned at locations across the slot for deflecting the filaments into zones of higher and lower filament concentration.

Nonwoven fabrics and nonwoven fabric composites in accordance with the present invention can be used in a variety of applications. For example, they are useful in diapers, adult incontinence products, feminine hygiene products such as panty shields and sanitary napkins, disposable medical products such as gowns or surgical drapes, protective clothing, house wrap, and specialty packaging. For diaper applications, the heavier basis weight zone can provide enhanced barrier properties and strength to certain areas of the diaper, such as the leg cuff, while the lower basis weight zone provides enhanced breathability and moisture permeability in the absorbent areas. For disposable garment or protective apparel applications, used either alone or in combination with a breathable film, the nonwoven fabric or composite of the present invention can provide extra strength in certain areas of the garment combined with improved breathability, comfort and softness in other areas. With proper selection of the width, configuration and spacing of the high/low basis weigh areas, unique design or aesthetic effects can be imparted to an end product formed from the nonwoven. For housewrap or specialty industrial packaging applications, certain zones can be provided with increased strength, or tear or puncture resistance.

### EXAMPLE 1

A spunbond nonwoven fabric in accordance with the invention was made by the following procedure using the Lurgi spunbond method for attenuating fibers and laying the resulting fibers on a moving wire. Commercially available polypropylene polymer, AMOCO Type 7956, was melted in an extruder then pumped through spinnerettes equipped with many holes. The resulting filaments were cooled in a quench zone, gathered into bundles, and the resulting bundles were fed into a row of Lurgi tubes of the general type well know in the spunbond art. The top of each Lurgi tube was equipped with an air gun that subjected the fibers in the bundle to high-pressure air such that the fibers were very rapidly accelerated. As is well know in the art, such acceleration provides tension in the spin line such that the fibers are drawn or attenuated to typical spunbond fiber denier of approximately 0.5 to 10 denier per filament (dpf). The attenuated fibers were then sprayed onto a moving wire to yield a web of nonwoven web of uniform basis weight across the CD direction of the web of approximately 16 GSM. As this web moved down the wire it passed under a second bank of Lurgi tubes that sprayed in selected areas of the moving web extra spunbond fibers such that in those selected areas or stripes of from 3.5 to 5 inches of width a basis weight of approximately 40 GSM was observed.

The resulting web of lighter and heavier basis weight stripes passed through a nip of one heated smooth and one heated patterned roll such that fibers of the web were spot bonded together with a resulting bond area of approximately 15%. The resulting nonwoven fabric, sample 21510A, was characterized to yield results given in Table 1. Results are designated for a heavy basis weight area of the web and for a light basis weight area of the web. The unique features of our invention are clearly demonstrated.

### EXAMPLE 2

A spunbond nonwoven product, not of the invention, was made by the following procedure using a slot spunbond method as generally described in U.S. Pat. No. 5,292,239 for attenuating fibers and laying the resulting fibers on a moving wire. Commercially available polypropylene polymer, AMOCO Type 7956, was melted in an extruder and then pumped through spinnerettes equipped with many holes. The resulting filaments, arranged in a continuous curtain extending across the CD direction of the machine, were cooled in a quench zone, and then introduced into a slot type draw or attenuation system such that the filaments were very rapidly accelerated. As is well know in the art, such acceleration provides tension in the spin line such that the filaments are drawn or attenuated to typical spunbond filament denier of approximately 0.5 to 10 dpf. The attenuated filaments were then laid on a moving wire to yield a web of uniform basis weight across the CD direction of the web of approximately 8 GSM. The resulting web of spunbond filaments was passed through a nip of one heated smooth and one heated patterned roll such that fibers of the web were spot bonded together with a resulting bond area of approximately 15%. The resulting nonwoven fabric 21505-02, not of the invention, was characterized to yield the results in Table 2.

### EXAMPLE 3

A spunbond nonwoven product of the invention was made as outlined below by spraying fibers of typical spunbond deniers onto selected areas of the spunbond fabric of Example 2. The spunbond nonwoven of Example 2 was unwound onto a moving wire. Polypropylene polymer, AMOCO Type 7956, was melted in an extruder then pumped through spinnerettes equipped with many holes. The resulting filaments were cooled in a quench zone, gathered into bundles, and the resulting bundles were fed into a row of Lurgi tubes of the general type well know in the spunbond art. The top of each Lurgi tube was equipped with an air gun that subjected the filaments in the bundle to high-pressure air such that the filaments were very rapidly accelerated. As is well know in the art, such acceleration provides tension in the spin line such that the filaments are drawn or attenuated to typical spunbond filament denier of approximately 0.5 to 10 dpf. The attenuated filaments were carefully sprayed onto selected areas of the spunbond nonwoven of Example 2 as this nonwoven was supported by the moving wire. The sprayed filaments resulted in regions or stripes of higher basis weight running in the MD direction on top of the spunbond fabric of Example 2. The resulting composite web was passed through a nip of one heated smooth and one heated patterned roll such that filaments of the web were spot bonded together. The resulting nonwoven, fabric 21505-06AB, an example of our invention, was characterized to yield results in Table 2. Results 21505-06A designate areas of high basis weight resulting from the extra filaments of typical spunbond denier from the Lurgi guns. Results 21505-06B characterize areas where the basis weight remained equal to that seen for Example 2. The unique features of our invention are clearly demonstrated.

### EXAMPLE 4

A laminate in accordance with the invention was made as outlined below. The nonwoven fabric of Example 3, a product of our invention was unwound onto a moving wire. Polypropylene polymer, EXXON 3546 commercially available and designed for meltblowing, was melted in an extruder then pumped through a meltblowing die where the resulting fibers of polypropylene were very rapidly attenuated with hot high pressure air into microfibers. The general meltblowing process is well known in the art, as for example is described in U.S. Pat. No. 4,041,203 and references cited therein. The resulting meltblown fibers were deposited onto the nonwoven fabric of Example 3, which was supported by the moving wire of the machine. The resulting web of Example 3, now coated with approximately 3 GSM of microfibers from the meltblowing process, was conveyed to a combining station where a roll of the nonwoven of Example 2 was unwound onto the microfiber coated face of the laminate. The resulting laminate, made from the combination of the spunbond fabric of Example 2, a layer of microfibers from meltblowing, and the spunbond fabric of Example 3, was passed through a nip of one heated smooth and one heated patterned roll such that fibers of the webs were spot bonded. The resulting nonwoven fabric laminate, sample 18710-03AB, was characterized to yield results in Table 2. Results 18710-03A designate areas of higher basis weight resulting from the combination of the fabric of Example 2, the microfibers from the meltblowing step, and the contribution of the fabric of Example 3 where the extra fibers of denier typical of the spunbond process are located. Results 18710-03B characterizes areas where the basis weight is the sum of the fabric of Example 2, microfibers from the meltblowing step, and the fabric of Example 3 where there is no contribution from the extra spunbond fibers from the Lurgi guns. The unique features of our invention are clearly demonstrated.

One skilled in the nonwoven art would recognize that Example 4, a product of our invention, could be made in an integrated operation by a machine equipped for example with one spunbond beam, a second spunbond beam designed to provide targeted areas of extra fibers of typical spunbond deniers, a third beam to provide microfibers from a meltblowing operation, and a final spunbond bond beam. Example 4 represents use of a pilot line where the preferred integrated process steps were achieved in a stepwise fashion to yield the product of our invention.

TABLE 1
SPUNBOUND FABRICS AND LAMINATES OF SUCH WITH AREAS OF HIGH AN LOWER SPUNBOND BASIS WEIGHT

| | | | | | | | Bweight | Bweight | Bweight | Bweight |
|---|---|---|---|---|---|---|---|---|---|---|
| | AIRPERM | AIRPERM | RCST | RCST | OPACITY | OPACITY | avg gsm | std n = 8 | avg gsm | std n = 8 |
| | avg cfm | std n = 8 | Avg cm | std n = 8 | Avg C2% | std n = 8 | CD | CD | MD | MD |
| 21510A - Heavy area | 443 | 42.2 | 7.5 | 1.60 | 29.6 | 5.76 | 38.6 | 1.54 | 42.3 | 6.74 |
| 21510A - Light area | 1058 | 69.9 | 3.1 | 0.64 | 14.3 | 1.52 | 15.0 | 1.33 | 16.5 | 2.20 |

| | HANDLE | HANDLE | CD TEN | CD TEN | CD ELON | CD ELON | CDTEA | CDTEA |
|---|---|---|---|---|---|---|---|---|
| | avg g | std n = 8 | Avg g | std n = 8 | Avg % | std n = 8 | avg ing/si | std n = 8 |
| 21510A - Heavy area | 29.0 | 8.7 | 1678 | 147 | 50 | 5.52 | 1130 | 164.2 |
| 21510A - Light area | 4.0 | 0 | 537 | 159 | 38 | 13.23 | 207 | 126.9 |

| | MD TEN | MD TEN | MD ELON | MD ELON | MDTEA | MDTEA |
|---|---|---|---|---|---|---|
| | avg g | std n = 8 | Avg % | std n = 8 | Avg ing/si | std n = 8 |
| 21510A - Heavy area | 2322 | 311 | 29.1 | 3.63 | 1419 | 276.9 |
| 21510A - Light area | 698 | 255 | 22.2 | 8.47 | 183 | 114.4 |

TABLE 2
SPUNBOND FABRICS AND LAMINATES OF SUCH WITH AREAS OF HIGH AND LOWER
SPUNBOND BASIS WEIGHT
Summary of Averages (n = 8)

| | | Std | | Std | | Std | | Std | | Std |
|---|---|---|---|---|---|---|---|---|---|---|
| | 21505-02 | Dev | 21505-06A | Dev | 21505-06B | Dev | 18710-03A | Dev | 18710-03B | Dev |
| Basis Weight (g/m²) | 8.1 | | 24.8 | | 8.3 | | 34.9 | | 21.8 | |
| CD Strip Tensiles | | | | | | | | | | |
| Basis Weight (g/m²) | 8.0 | 1.3 | 25.2 | 4.1 | 8.3 | 1.2 | 36.1 | 3.3 | 21.8 | 2.2 |
| Peak Load (g) | 107 | 54 | 515 | 220 | 109 | 40 | 864 | 348 | 291 | 65 |
| Peak Elongation (%) | 38.3 | 13.5 | 31.8 | 10.0 | 68.4 | 29.8 | 30.7 | 10.2 | 41.4 | 7.63 |
| TEA (ing/in²) | 34.9 | 18.8 | 170.2 | 81.1 | 43.7 | 22.5 | 364 | 240 | 108 | 25.6 |
| MD Strip Tensiles | | | | | | | | | | |
| Basis Weight (g/m²) | 8.1 | 0.8 | 24.3 | 5.8 | 8.2 | 1.2 | 33.7 | 7.2 | 21.8 | 1.6 |
| Peak Load (g) | 614 | 296 | 1195 | 583 | 524 | 218 | 1890 | 460 | 1876 | 356 |
| Peak Elongation (%) | 13.4 | 4.02 | 13.9 | 4.31 | 8.9 | 1.95 | 9.89 | 2.92 | 11.6 | 2.26 |
| TEA (ing/in²) | 84.5 | 67.6 | 262 | 209 | 47.9 | 29.7 | 291 | 138 | 222 | 97.1 |
| Air Permeability (cfm) | 1275 | 207 | 534 | 60.9 | 1339 | 130 | 108 | 9.17 | 211 | 22.8 |
| Handle-O-Meter (grams) | 3.1 | 0.4 | 11.4 | 3.4 | 3.9 | 0.4 | 29.0 | 3.5 | 10.1 | 1.0 |
| Opacity (%) | 8.1 | 2.4 | 22.1 | 6.5 | 7.1 | 1.6 | 39.6 | 2.6 | 29.1 | 2.5 |
| RCST (cm) | 0.5 | 0.71 | 2.8 | 1.94 | 1.1 | 0.79 | 35.8 | 7.52 | 23.1 | 7.6 |

The test methods used in obtaining the data in Tables 1 and 2 are as follows:
Basis weight - ASTM D3776-96,
Tensile Properties - ASTM D5035-95 (modified to 2 inch gage length and 5 inches/minute extension rate,
Air permeability - Textest model FX3300 with 20 square centimeter orifice and 125 Pascal pressure,
Handle-O-meter - INDA IST 90.3,
Opacity - INDA IST 60.1-95,
RCST (Rising Column Strike Through) - AATCC 127-1985.

The above tests are employed to evaluate nonwovens for fitness for use in different applications, for example as components in diapers, disposable or protective garments, special packaging, or house wrap. Tensile properties will provide an estimate of the strength of the nonwoven when put under tension. A high value would characterize a strong nonwoven fabric. Air permeability characterizes the volume of air that can flow through the nonwoven in unit time. For certain applications such as diaper backsheet or protective clothing a high air permeability would signify a high degree of air exchange through the nonwoven with a corresponding increase in the comfort to the wearer of the diaper or protective clothing. Handle-O-meter estimates the softness of the nonwoven by measuring the ease to bend the nonwoven. A low number in this test suggests little resistance to bending the nonwoven and suggests a softer nonwoven that for example in protective clothing would more easily conform to the wearer's body. The Opacity test measures the percent of light that is blocked out by the nonwoven. For disposable clothing such a used in the medical examination room a higher opacity would provide the wearer with more privacy. RCST provides an estimate of the barrier properties of the nonwoven. For a diaper application such a use as part of a diaper backsheet or leg cuff a higher RCST might insure that leakage is reduced.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A spunbond nonwoven fabric comprising a multiplicity of substantially continuous filaments which form a web having a length dimension and a width dimension, the filaments being arranged to define a substantially uniform web basis weight along one of said dimensions, and in the other of said dimensions, the filaments being arranged to define adjacent zones of a relatively lower web basis weight and a relatively higher web basis weight which is at least 25 weight percent greater than the basis weight of the lower basis weight zone.

2. A spunbond nonwoven fabric according to claim 1, wherein the basis weight of the higher basis weight zone is at least 40 weight percent greater than the basis weight of the lower basis weight zone.

3. A spunbond nonwoven fabric according to claim 1, wherein the fabric is in the form of roll goods of a predetermined substantially uniform width and of indeterminate length, and wherein said zones of relatively lower and higher basis weight extend continuously in the length dimension.

4. A spunbond nonwoven fabric according to claim 3 which includes at least two of said zones of relatively lower basis weight and a zone of relatively higher basis weigh located therebetween.

5. A spunbond nonwoven fabric according to claim 3 which includes a central zone of higher basis weight located medially of opposite side edges of the fabric and edge zones of lower basis weight located on opposite sides of said central zone, the lower basis weight edge zones adjoining the central zone and extending outwardly therefrom to the opposite side edges of the fabric, and wherein the basis weight of the higher basis weight central zone is at least 40 weight percent greater than the basis weight of the lower basis weight edge zones.

6. A composite nonwoven fabric comprising the spunbond nonwoven fabric according to claim 1 combined with at least one additional layer.

7. A composite nonwoven fabric according to claim 6, wherein said at least one additional layer comprises a layer of meltblown fibers.

8. A composite nonwoven fabric according to claim 6, wherein said at least one additional layer comprises a film.

9. A composite nonwoven fabric according to claim 6, including a layer of meltblown fibers positioned in opposing face-to-face relation with said spunbond nonwoven fabric, and an additional spunbond nonwoven fabric positioned in opposing face-to-face relation with said layer of meltblown fibers, the respective layers being bonded together to form a unitary coherent composite nonwoven fabric with the spunbond layers forming the opposite outer surfaces of the composite nonwoven fabric.

10. A composite nonwoven fabric according to claim 9, wherein said additional spunbond nonwoven fabric has a uniform basis weight throughout.

11. A composite nonwoven fabric according to claim 9, wherein said additional spunbond nonwoven fabric also has adjacent zones of a relatively lower web basis weight and a relatively higher web basis weight which is at least 25 weight percent greater than the basis weight of the lower basis weight zone, and wherein the two spunbond nonwoven fabrics are arranged with the zones of relatively higher basis weight and lower basis weight in registration with one another.

12. A spunbond nonwoven fabric comprising a multiplicity of substantially continuous melt spun polymeric filaments which form a web having a machine direction extending lengthwise of the fabric and a cross-machine direction extending widthwise of the fabric, the filaments being arranged to define a substantially uniform web basis weight along the machine direction of the fabric, and in the cross-machine direction, the filaments being arranged to define alternating adjacent zones of a relatively lower web basis weight and a relatively higher web basis weight which is at least 25 weight percent greater than the basis weight of the lower basis weight zone.

13. A composite nonwoven fabric comprising a spunbond nonwoven layer comprising a multiplicity of substantially continuous melt spun polymeric filaments which form a web having a machine direction extending lengthwise of the fabric and a cross-machine direction extending widthwise of the fabric, the filaments being arranged to define a substantially uniform web basis weight along the machine direction of the fabric, and in the cross-machine direction, the filaments being arranged to define alternating adjacent zones of a relatively lower web basis weight and a relatively higher web basis weight which is at least 25 weight percent greater than the basis weight of the lower basis weight zone, and a layer of meltblown fibers positioned in laminar surface-to-surface relationship with said spunbond nonwoven layer and bonded thereto at intermittent discrete bond regions to form a unitary composite nonwoven fabric.

14. A composite nonwoven fabric comprising first and second outer spunbond nonwoven layers, each comprising a multiplicity of substantially continuous filaments which form a web having a length dimension and a width dimension, the filaments in at least said first layer being arranged to define a substantially uniform web basis weight along one of said dimensions, and in the other of said dimensions, the filaments being arranged to define adjacent zones of a relatively lower web basis weight and a relatively higher web basis weight which is at least 25 weight percent greater than the basis weight of the lower basis weight zone, and an intermediate layer of meltblown fibers positioned between and in laminar surface-to-surface relationship with first and second outer spunbond layers and bonded thereto at intermittent discrete bond regions to form a unitary composite nonwoven fabric.

15. A composite nonwoven fabric according to claim 14, wherein said second outer spunbond nonwoven layer has a substantially uniform basis weight along both its width dimension and its length dimension.

16. A composite nonwoven fabric according to claim 14, wherein said second outer spunbond nonwoven layer also has its filaments arranged to define a substantially uniform web basis weight along one of said dimensions, and in the other of said dimensions, the filaments being arranged to define adjacent zones of a relatively lower web basis weight and a relatively higher web basis weight which is at least 25 weight percent greater than the basis weight of the lower basis weight zone.

17. A composite nonwoven fabric according to claim 16, wherein the zones of relatively higher basis weight in said first and second outer spunbond layers are positioned in registration with one another.

18. A composite nonwoven fabric comprising first and second outer spunbond nonwoven layers, each comprising a multiplicity of substantially continuous melt spun polymeric filaments which form a web having a machine direction extending lengthwise of the fabric and a cross-machine direction extending widthwise of the fabric, the filaments being arranged to define a substantially uniform web basis weight along the machine direction, and in the cross-machine direction the filaments being arranged to define alternating adjacent zones of a relatively lower web basis weight and a relatively higher web basis weight which is at least 25 weight percent greater than the basis weight of the lower basis weight zone, and an intermediate layer of meltblown fibers positioned between and in laminar surface-to-surface relationship with first and second outer spunbond layers and bonded thereto at intermittent discrete bond regions to form a unitary composite nonwoven fabric.

19. A composite nonwoven fabric according to claim 18, wherein the relatively lower basis weight zones of said first and second outer spunbond nonwoven layer are correspondingly positioned in overlying relation to one another and the relatively higher basis weight zones of said first and second outer spunbond nonwoven layer are also correspondingly positioned in overlying relation to one another.

20. A composite nonwoven fabric according to claim 18, which includes at least two of said zones of relatively lower basis weight and a band of relatively higher basis weigh located therebetween.

21. A composite nonwoven fabric according to claim 18 which includes a central zone of higher basis weight located medially of opposite side edges of the fabric and edge zones of lower basis weight located on opposite sides of said central zone, the lower basis weight edge zones adjoining the central zone and extending outwardly therefrom to the opposite side edges of the fabric, and wherein the basis weight of the higher basis weight central zone is at least 40 weight percent greater than the basis weight of the lower basis weight edge zones.

22. A diaper which includes as a component thereof a nonwoven fabric according to claim 1.

23. A garment which includes as a component thereof a nonwoven fabric according to claim 1.

24. A process for producing a spunbond nonwoven fabric comprising advancing an endless collection belt along a path of travel in a machine direction, extruding a multiplicity of substantially continuous melt spun polymeric filaments from an extrusion die extending across the machine direction, directing the melt spun filaments into and through an attenuator device and attenuating the filaments, discharging the filaments from the attenuator device onto the advancing collection belt to form the filaments into a web, and wherein the step of discharging the filaments from the attenuator device includes controllably discharging the filaments at differing concentrations in the cross-machine direction so that the filaments define alternating adjacent zones of a relatively lower web basis weight and a relatively higher web basis weight which is at least 25 weight percent greater than the basis weight of the lower basis weight zone.

25. A process according to claim 24, including the further step of directing the web of filaments through the nip of a heated calender and forming intermittent discrete bond regions bonding the filaments together to form a unitary composite nonwoven fabric.

26. A process according to claim 24, including the further step of bonding the thus-formed web of substantially continuous filaments to at least one additional layer containing meltblown fibers to form a composite nonwoven fabric.

27. A process for producing a composite nonwoven fabric which comprises forming first and second webs of substantially continuous filaments, each in accordance with the process of claim 24, directing the thus formed webs on opposite sides of a nonwoven layer containing meltblown fibers, and bonding the first and second webs and the nonwoven layer containing meltblown fibers first and second outer spunbond layers at intermittent discrete bond regions to form a unitary composite nonwoven fabric.
